(19) United States
(12) Patent Application Publication
(10) Pub. No.: US 2014/0279523 A1
(43) Pub. Date: Sep. 18, 2014

(54) System and Method for Authenticating Payment Transactions

(71) Applicants: Joe M. Lynam, Morgan Hill, CA (US); Evan B. Meyer, Danville, CA (US); Mark E. Snycerski, San Jose, CA (US); Bradford Singer, Sudbury, MA (US)

(72) Inventors: Joe M. Lynam, Morgan Hill, CA (US); Evan B. Meyer, Danville, CA (US); Mark E. Snycerski, San Jose, CA (US); Bradford Singer, Sudbury, MA (US)

(21) Appl. No.: 13/841,318

(22) Filed: Mar. 15, 2013

(51) Int. Cl. G06Q 20/32

(52) U.S. Cl. CPC G06Q 20/3226
USPC 705/44

(57) ABSTRACT

A request to authorize a payment transaction initiated on the client device is received by the system. In some embodiments, the request is received from a mobile client device connected to a cellular communications network. The request includes an IP address associated with a client device and a cellular phone number associated with the client device. The IP address is determined automatically without human intervention from the request. A cellular telephone carrier system associated with the cellular communications network is then queried using the cellular phone number associated with the client device. A response is received from the carrier system. The response includes the current IP address associated with the client device. The payment transaction is authorized when the IP address received from the carrier system matches the IP address received from the client device.

### RELATED APPLICATIONS

This application is related to U.S. patent application Ser. No. ______, filed ______, 2013 titled “Location Based Payment System,” which application is incorporated by reference herein in its entirety.

### TECHNICAL FIELD

The disclosed embodiments generally relate to electronic commerce, and specifically to a system and method for authenticating a payment transaction initiated by a portable client device connected to a cellular communications network by corroborating client device specific data.

### BACKGROUND

Increasingly merchants offer goods and/or services which may be purchased via communications networks. Customers often purchase goods and/or services via a communications network using a variety of means such as credit cards, debit cards, person to person on-line payment methods, or other means. However, customers may be hesitant to supply payment details over the communications network for security reasons. Similarly, merchants may be hesitant to provide goods and/or services for similar security concerns. It would be advantageous to provide users and merchants with a more secure method of purchasing goods and/or services by first authenticating payment transactions prior to authorizing a purchase.

### SUMMARY

Various embodiments of systems, methods and devices within the scope of the appended claims each have several aspects, no single one of which is solely responsible for the desirable attributes described herein. Without limiting the scope of the appended claims, some prominent features are described herein. After considering this discussion, and particularly after reading the section entitled “Detailed Description” one will understand how the features of various embodiments are used.

Some embodiments provide a method for authorizing a payment transaction initiated on a mobile client device connected to a cellular communication network. The method is performed at a system having one or more processors and memory storing one or more programs for execution by the one or more processors. A request to authorize a payment transaction initiated on the client device is received by the system. In some embodiments, the request is received from a mobile client device connected to a cellular communications network. The request includes an IP address associated with a client device and a cellular phone number associated with the client device. In some embodiments, the IP address is determined automatically without human intervention from the request. In some embodiments, the cellular phone number is determined automatically without human intervention, while in other embodiments the cellular phone number is obtained from direct user input into the mobile client device.

A carrier system associated with the cellular communications network is then queried using the cellular phone number associated with the client device. A response is received from the carrier system. The response includes an IP address associated with the client device. The payment transaction is then at least partially authenticated or authorized when the IP address received from the carrier system matches the IP address received from the client device.

In some embodiments, a request to authorize a payment transaction is received, where the payment transaction is initiated on a portable client device connected to a cellular communications network. The request includes first client device data including an IP address and a unique identifier both associated with the client device. The unique identifier may include a cellular phone number, a client device ID, a SIM card number, or an IMEI number. An authentication system is then queried using a subset of the first client device data. The subset of first client device data may includes at least one of: the IP address associated with a client device, the cellular phone number associated with a client device, a client device ID, a SIM card number associated with a client device, or an IMEI number associated with a client device. Alternatively, the subset of the first client device data may include at least one of: the IP address associated with a client device, the cellular phone number associated with a client device, a client device ID, a SIM card number associated with a client device, or an IMEI number associated with a client device. A response is received from the authentication system that includes second client device data distinct from the subset of the first client device data. If at least some of the second client device data received from the authentication system matches at least some of the second client device data received from the client device, then the payment transaction is at least partially authenticated or authorized.

In some embodiments, before the request is received, the system first receives a payment processing transaction request from the mobile client device or a merchant, and transmits a request for client device data to the mobile client device or the merchant.

In some embodiments, the authentication system is operated by an internet service provider. In some embodiments, authentication or authorization is first attempted using the phone number, and if unsuccessful then using a device identifier. Once authorized, payment may be completed via credit card, debit card, or the like. In some embodiments, authentication or authorization is only permitted if the mobile client device is within a certain geographic region.

If the IP address received from the carrier system does not match the IP address received from the client device, then a failure message may be provided and/or the user of the mobile client device is notified that illicit activity may be occurring with the mobile client device.

Some embodiments provide an authentication system having one or more processors, memory, and one or more programs stored in the memory. The one or more programs include instructions for performing the above methods.

Some embodiments provide a non-transitory computer readable storage medium storing one or more programs configured for execution by one or more processors of an authentication system. The one or more programs include instructions for performing the above methods.

### BRIEF DESCRIPTION OF THE DRAWINGS

So that the manner in which features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other effective aspects.

FIG. 1 is a block diagram of a mobile transactions processing environment, in accordance with some embodiments.

FIG. 2 is a block diagram of a client device, in accordance with some embodiments.

FIG. 3 is a block diagram of a retailer/service provider system, in accordance with some embodiments.

FIG. 4 is a block diagram of an authentication server system, in accordance with some embodiments.

FIGS. 5A and 5B are block diagrams illustrating the client device data structures associated with various types of client devices, in accordance with some embodiments.

FIG. 6 is a flow-chart of an authentication method performed by a client device, in accordance with some embodiments.

FIG. 7 is a flow-chart of an authentication method performed on a merchant server, in accordance with some embodiments.

FIG. 8 is a flow-chart of an authentication method performed on an authentication server, in accordance with some embodiments.

FIG. 9 is a flow-chart of another authentication method performed on an authentication server, in accordance with some embodiments.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Various aspects of embodiments within the scope of the appended claims are described below. It should be apparent that the aspects described herein may be embodied in a wide variety of forms and that any specific structure and/or function described herein is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first contact could be termed a second contact, and, similarly, a second contact could be termed a first contact, which changing the meaning of the description, so long as all occurrences of the “first contact” are renamed consistently and all occurrences of the second contact are renamed consistently. The first contact and the second contact are both contacts, but they are not the same contact.

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Client devices that communicate with other devices typically have device identifiers that are unique to each device. A mobile phone device typically has one or more unique identifiers, including the device's phone number. For the purposes of this description, mobile phones include cellular phones, satellite phones, wireless VOIP phones, or the like. Client devices, such as mobile phones, also typically communicate over communications networks, using the TCP/IP communications protocol. The TCP/IP communications protocol IP assigns a numeric addresses to every client, server and router in the network. This numeric address is known as an IP address, and is typically dynamically assigned by an internet service provider and/or a phone carrier. By dynamic it is meant that the client device's assigned IP address is reassigned for each TCP/IP communication session. The IP address assigned to any device is dependent on various factors, including the block of IP addresses assigned to the internet service provider or phone carrier, the current location of the client device, the time that the client device requested the address, the current communication load on the communications network, etc.

In order to facilitate communications to and from a mobile phone, a phone carrier supporting the client device maintains certain data including a client device's currently assigned IP address, the device's phone number, the client device's device ID (e.g., the International Mobile Station Equipment Identity (IMEI) or Integrated Circuit Card ID (ICCID)). The IMEI is a number, usually unique, used to identify 3GPP (i.e., GSM, UMTS and LTE) and iDEN mobile phones, as well as some satellite phones. The IMSI is a unique identification associated with all GSM, UMTS and LTE network SIM cards. The ICCID is unique number assigned to a SIM card in a GSM cellphone.

Because each device includes multiple independent unique identifiers at any instant in time, a device connected to a mobile phone communication network can be authenticated by, for example, a third party or a merchant obtaining a first unique identifier of the mobile device (e.g., phone number) and a second unique identifier of the mobile device (e.g., IP address), and then providing just the first unique identifier to the mobile phone carrier and requesting that the mobile phone carrier provide the second unique identifier currently associated with the first unique identifier to the third party. For example, during a payment transaction, a merchant obtains the phone number and IP address from the mobile device. The third party or merchant then sends the phone number to the carrier that in turn sends back the IP address currently associated with that phone number. The third party or merchant then compares the IP address obtained from the phone to the IP address obtained from the carrier. If both IP addresses match, then the third party or merchant has a high confidence that the phone that initiated the transaction request is in fact the phone associated with the phone number provided by the phone. The third party or merchant then authenticates the payment transaction. The third party or merchant may use more than two unique identifiers to increase the confidence level.

Merchants can benefit from this authentication because after the authentication they can have a higher level of confidence that the device being used for the purchase is legitimate. It may also help with merchant issues such as friendly fraud, where a user lies about having purchased a product. For example, if the merchant can prove that the client's device was the device used to perform the purchase, then it is harder for the user to claim that the purchase was not authorized by them. Similarly, users will benefit from the authentication in identity theft situations. For example, if a user's phone number is provided by someone else on another device during an authentication process, authentication would not be approved and the user could be notified that the phone number may have been stolen or been used illicitly.

Similarly, a client device can be authenticated by, for example, providing the current IP address of the client device to the carrier, requesting the phone number of the device currently associated with that IP address, and then comparing the phone number received from the device with the phone number received from the carrier.

In some embodiments, the mobile number and the IP address are obtained automatically, i.e., without human intervention, from the mobile client device when a payment transaction is initiated. In other embodiments, a client device may not have an associated phone number or may not opt to disclose it. For example, an Apple iPad connected to a 4G cellular network may not have an associated phone number. In these embodiments, any other unique identifier, such as the client device ID (e.g., IMEI or ICCID), can be used in a similar manner to authenticate the client device. A client device can be authenticated by for example, providing the device ID for the client device and requesting that an authorization system, such as phone carrier or an internet service provider, provide the IP address currently associated with that client device ID. Thus, when the IP address provided by the phone carrier matches the IP address provided by the client device, the third party can authenticate that the client device requesting a payment transaction is not being spoofed. Similarly, a client device can be authenticated by for example, providing the device's currently assigned IP address and requesting that a phone carrier or an internet service provider provide the client device ID currently associated with that IP address.

It is further noted, that in some instances a merchant server could perform some or all of third party's functions. Similarly, all of parties such as the client, the merchant, the third party (such as an authentication server), the phone carrier, and the internet service provider may take on different rolls in the authentication process depending on the specific embodiment.

In some embodiments, once the client device has been authenticated, the client device is confirmed as being trustworthy. In some embodiments, when the client device is being used for a payment transaction, the payment transaction is then authorized to proceed. The user of the client device may complete the transaction using a credit card, debit card, bill-to-phone-account, or any other suitable payment mechanism. For example, in some embodiments the user may utilize a system that adds the cost of the transaction directly to a user's phone bill/telephone account as explained in Applicant's U.S. Pat. No. 7,080,049 entitled “Method and System for Processing a Transaction,” incorporated by reference herein in its entirety.

FIG. 1 is a block diagram of an embodiment of a mobile transactions processing environment 100. While certain specific features are illustrated, those skilled in the art will appreciate from the present disclosure that various other features have not been illustrated for the sake of brevity and so as not to obscure more pertinent aspects of the implementations disclosed herein. To that end, the client-server environment 100 includes a retailer/service provider 140, an authentication service provider server 160, a mobile phone operator network 120 (e.g., carrier infrastructure), at least one mobile client device 124 (e.g., smartphone or tablet), a client desktop device 114, and a communications network 110 (e.g., the Internet). The mobile client device is also referred to herein as a client, client device, or mobile device. Each of the service provider 140, the authentication service provider server 160, desktop device 114, and the mobile client device 124 are capable of communication through a suitable combination of the mobile phone operator network 120, internet service provider 111, and the network 110 in order to exchange information with one another and/or other devices and systems. Moreover, while FIG. 1 only includes one of each of the aforementioned devices and systems, those skilled in the art will appreciate from the present disclosure that any number of such devices and/or systems may be provided in a client-server environment, and particular devices may be altogether absent. In other words, the client-server environment 100 is merely an example provided to discuss more pertinent features of the present disclosure.

The mobile device 124 allows a user to make payment transactions, such as purchasing goods or services.

The mobile phone operator network 120 is operable to connect client devices (114/124) to the network 110. To that end, for example, the mobile phone operator network 120 includes a radio network controller (RNC) 122 and base stations 123. Those skilled in the art will appreciated from the present disclosure that the carrier infrastructure of a mobile network typically includes, among many other well known devices, a number of RNC units that are each provisioned to manage a number of respective base stations. Additionally, a base station 123 is typically provisioned to provide coverage to a geographic area within which subscribing mobile devices can access the mobile network, so for example base station 123a covers a different geographic area than base station 123b. Where the mobile phone network is a satellite network, the mobile phone operator network 120 includes one or more satellites and/or other equipment. Accordingly, FIG. 1 merely illustrates the features of the carrier infrastructure of a mobile network pertinent to the implementations described in greater detail herein.

As will be discussed in greater detail below, the client devices, such as the mobile device 124 and the desktop device 114 each communicate with the service provider 140 by communicating with the internet service provider 111 and/or the mobile phone operator network 120. To facilitate the interactions, the internet service provider 111 has a look-up table 111a storing client device information such as device IP and a currently assigned IP address. Similarly, the radio network controller 112 (or any other suitable server within the mobile phone operator network 120) also includes a look-up table 122a which stores client device information such as device ID, phone number, and currently assigned IP address. The look-up tables are explained in more detail with respect to FIGS. 5A and 5B.

Additionally, the mobile phone operator network 120 typically includes a gateway server 121 between the mobile network and an IP based communication network, such as the Internet. The gateway server 121 provides physical layer domain mapping between the mobile network and the IP based communication network, such as the network 110 so that data can be transferred between devices on both networks. For example, the mobile device 124 is operable on the mobile phone operator network 120 of the mobile network, which includes for example, the base station 123 and the RNC 122. As such, data from the mobile device 124 and destined for the service provider 140 is first transmitted to the base station 123 serving the mobile client device 124. The data is then passed up through the mobile phone operator network 120 to the gateway server 121 where it is mapped to a different physical layer infrastructure (typically using a different protocol) associated with the network 110 so that it can be routed to the retailer/service provider 140 to complete the communication. In turn, an acknowledgment or another responsive communication is returned via the network 110 and through the gateway server 121 using a complementary mapping so that the communication can be routed to the mobile device 124.

As is appreciated by those skilled in the art, an IP data communication network, such as the network 110, or a private network, may be any combination of wired and wireless local area network (LAN) and/or wide area network (WAN), such as an intranet and/or an extranet. It is sufficient that the IP data communication network provides communication capability between various types of internet-enabled client devices, servers and database system. In some implementations, an IP data communication network uses the HyperText Transport Protocol (HTTP) to transport information using the Transmission Control Protocol/Internet Protocol (TCP/IP). HTTP permits a client device to access various resources available via the communication network. However, the various implementations described herein are not limited to the use of any particular protocol.

In some embodiments, the retailer/service provider 140 includes, for example, a service provider server 141 and a database 142. In some implementations, the retailer/service provider 140 is implemented as a single server system, while in other implementations it is implemented as a distributed system of multiple servers. Solely for convenience of explanation, the retailer/service provider 140 is described below as being implemented on a single server system.

Similarly, in some embodiments, the authentication service provider server 160 also includes, for example, an online authentication server 161 and a database 162. In some implementations, the authentication service provider server 160 is implemented as a single server system, while in other implementations it is implemented as a distributed system of multiple servers. Solely for convenience of explanation, the authentication service provider server 160 is described below as being implemented on a single server system.

FIG. 2 is a diagram of an embodiment of a client device 114 or 124. While certain specific features are illustrated, those skilled in the art will appreciate from the present disclosure that various other features have not been illustrated for the sake of brevity and so as not to obscure more pertinent aspects of the example implementations disclosed herein. As a non-limiting example, in some implementations the client device 114/124 includes one or more processing units (CPU's) 202, one or more network or other communications interfaces 208, a carrier network interface 207, a memory 205, a digital camera 209, and one or more communication buses 204 for interconnecting these and various other components.

The one or more communication buses 204 may include circuitry (sometimes called a chipset) that interconnects and controls communications between system components. The client device 114/124 optionally may include a user interface 201 comprising a display device 203 and an input means 253 (such as a keyboard, touch screen, or voice activated input mechanism). The memory 205 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 205 may optionally include one or more storage devices remotely located from the CPU(s) 202. The memory 205, including the non-volatile and volatile memory device(s) within the memory 205, comprises a non-transitory computer readable storage medium.

In some embodiments, the memory 205 or the non-transitory computer readable storage medium of the memory 205 stores the following programs, modules and data structures, or a subset thereof including an operating system 210, a network communications controller 220, an authentication processing module 230, one or more client applications 240, and a GPS module 250.

The operating system 210 includes procedures for handling various basic system services and for performing hardware dependent tasks. To that end, in some implementations, the operating system 210 stores and/or manages a number of device identifiers 211, including for example, a manufacturer device ID 212, a phone number 213, a device registration information 214, as well as other identifiers like a SIM card associated with a home country, a SIM card associated with a country or location in which the user is travelling, a dedicated number (e.g., a Google Voice number), or any other suitable identifier. In some embodiments, these identifiers 211 are stored on a SIM card within the device.

The communications controller 220 facilitates communication with other devices via the network interface 208 and the carrier network interface 207. To that end, in some implementations, the communications controller 220 stores and/or manages communication control information 221, including for example, a phone number 222, an IP address 223, carrier registration information 224, and ISP (Internet service provider) registration information 225.

The authentication processing module 230 is configured to operate in accordance with instructions sent from an authentication service provider 160 or a retailer/service provider 140, as discussed below with reference to FIGS. 6-9. To that end, the authentication processing module 230 includes computer readable instructions 231, metadata 232 and transaction heuristics 233.

The one or more client applications 240 include applications, programs and/or user utilities that provide functionality on the client device 114/124. For example, in some embodiments, the client device 114/124 includes a web browser 241 and a server provider application 242, each of which includes a suitable combination of computer readable instructions, metadata and operation heuristics.

The GPS module 250 is provided to enable a mobile client device 124 to obtain location data by receiving GPS satellite signals. To that end, as would be understood by those skilled in the art the GPS module 250 includes computer readable instructions 251 and location data 252.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 205 may store a subset of the modules and data structures identified above. Furthermore, memory 205 may store additional modules and data structures not described above.

FIG. 3 is a block diagram of an embodiment of a merchant/service provider 140. While certain specific features are illustrated, those skilled in the art will appreciate from the present disclosure that various other features have not been illustrated for the sake of brevity and so as not to obscure more pertinent aspects of the example implementations disclosed herein. In some implementations, the service provider 140 is implemented as a single server system, while in other implementations it is implemented as a distributed system of multiple servers. For convenience of explanation herein, the service provider 140 is described below as being implemented on a single server system. To that end, as a non-limiting example, in some implementations the service provider 140 includes one or more processing units (CPU's) 302, one or more network or other communications interfaces 308, a memory 305, and one or more communication buses 304 for interconnecting these and various other components.

The one or more communication buses 304 may include circuitry (sometimes called a chipset) that interconnects and controls communications between system components. The memory 305 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 305 may optionally include one or more storage devices remotely located from the CPU(s) 302. The memory 305, including the non-volatile and volatile memory device(s) within the memory 305, comprises a non-transitory computer readable storage medium.

In some implementations, the memory 305 or the non-transitory computer readable storage medium of the memory 305 stores the following programs, modules and data structures, or a subset thereof including an operating system 310, a network communications controller 320, a transactions database 330, an inventory/service database 340, and a payment processing module 350.

The operating system 310 includes procedures for handling various basic system services and for performing hardware dependent tasks.

The communications controller 320 facilitates communication with other devices via the network interface 308. In some implementations, the communications controller 320 manages IP sockets 321 with one or more client devices. Open sockets, such as No. 1 322 through No. N 323, are each associated with an IP address, such as IP address 322a shown for socket No. 1 322. The transactions database 330 is provided to store records of payments, along with transaction metadata and heuristics. The inventory/service database 340 includes data about and associated with the products and/or services that may be purchased from the retailer/service provider.

The payment processing module 350 is provided to process payments in coordination with a client device 114/124 and the authentication service provider 160. To that end, the payment processing module 350 includes an authentication processing module 360. In some implementations, the authentication processing module 360 is configured to manage a payment authentication process to reduce the potential for fraud and facilitate ease-of-service for location based transactions. To that end, the authentication processing module 360 includes computer readable instructions 361, metadata 362, transaction heuristics 363, and client information 370. Client information 370, for an exemplary Client No. 1 371 includes a device ID 371a, a client device phone number 371b, a currently assigned IP address 371, and optional location data 371d. In other embodiments a subset of the above information is provided. Additional clients through client N 372, also include some of all of the aforementioned client information.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 305 may store a subset of the modules and data structures identified above. Furthermore, memory 305 may store additional modules and data structures not described above.

FIG. 4 is a block diagram of an embodiment of an authentication service provider 160. While certain specific features are illustrated, those skilled in the art will appreciate from the present disclosure that various other features have not been illustrated for the sake of brevity and so as not to obscure more pertinent aspects of the example implementations disclosed herein. In some implementations, the authentication service provider 160 is implemented as a single server system, while in other implementations it is implemented as a distributed system of multiple servers. For convenience of explanation herein, the authentication service provider 160 is described below as being implemented on a single server system. To that end, as a non-limiting example, in some implementations the authentication service provider 160 includes one or more processing units (CPU's) 402, one or more network or other communications interfaces 408, a memory 405, and one or more communication buses 404 for interconnecting these and various other components.

In some implementations, the memory 405 or the non-transitory computer readable storage medium of the memory 405 stores the following programs, modules and data structures, or a subset thereof including an operating system 410, a network communications module 420, a carrier communications module 430, and transactions processing module 440.

The operating system 410 includes procedures for handling various basic system services and for performing hardware dependent tasks.

The network communications module 420 facilitates IP data communication with other devices via the network interface 308. The carrier communications module 430 facilitates communication on one or more mobile networks operated by respective carriers. To that end, the carrier communications module 430 stores and/or manages available carrier information 431, which includes individual carrier data 431-1 to 431-n.

The transactions processing module 440 is provided to facilitate transactions with particular client devices. To that end, the transactions processing module 440 includes computer readable instructions 441, metadata 442, heuristics 443, and transactions information 450. In some implementations, the transactions information 450 includes data for individual transactions, Transaction No. 1 460 to Transaction No. N 470. An exemplary client transaction No. 1 460 includes client device data 461 and an authentication result 462. Specifically, in exemplary Transaction No. 1 460, the client device date 461 includes the client device ID 461a, the client device phone number 461b, the currently assigned IP address 461c, and optionally device location data 461d. In other embodiments a subset of the above information is provided. Additional transactions through transactions No. N 470, also include some of all of the aforementioned device data 461.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 405 may store a subset of the modules and data structures identified above. Furthermore, memory 405 may store additional modules and data structures not described above.

Although FIGS. 2-4 show embodiments of a client device 114/124, a retailer/service provider 140, and authentication service provider 160 respectively, FIGS. 2-4 are each intended more as functional descriptions of the various features which may be present than as a structural schematic of the embodiments described herein. In practice, and as recognized by those of ordinary skill in the art, items shown separately could be combined and some items could be separated. For example, some items shown separately in FIGS. 3 and 4 could be implemented by one or more servers. The actual number of servers used to implement an authentication server system or a retailer/service provider server system and how features are allocated among them will vary from one implementation to another.

FIGS. 5A and 5B are block diagrams illustrating an embodiment of client device data structures associated with various types of client devices 114/124. The structures shown in FIGS. 5A and 5B include client device data from a plurality of devices. In some embodiments, the device data is stored in a look-up table (LUT) database 111a of an internet Service Provider in FIG. 5A. In other embodiments, the device data is stored in a look-up table (LUT) database 122a of a Radio Network Controller 122 in FIG. 5B.

FIG. 5A illustrates a look-up table 111a listing of client devices without an associated device phone number, such as a desktop device 114. In this embodiment, each client device listed in the look-up table database 111a includes a device ID 504 and an associated IP address 502. In some embodiments, the look-up table database 111a stores dynamically assigned IP addresses for a plurality of individual devices, which includes individual IP address data 502a, 502b, to 502m. In some embodiments, the look-up table database 111a stores device IDs for a plurality of individual devices, which includes device IDs 504a, 504b, to 504m.

FIG. 5B illustrates a look-up table 122a listing of client devices having an associated client device phone number, such as a mobile device 124 such as a smart phone. In this embodiment, each client device listed in the look-up table database 122a includes a device ID 504, a phone number 506, and an associated dynamically assigned IP address 502. In some embodiments, the look-up table database 122a stores dynamically assigned IP addresses and device ID numbers for a plurality of individual devices, such as 502a, 502b, to 502m and 504a, 504b, to 504m shown in FIG. 5A. In some embodiments, the look-up table database 122a stores phone numbers for a plurality of individual devices, which includes device IDs 506a, 506b, to 506m.

It is noted that in some embodiments, only the phone number 506 and dynamically assigned IP address 502 are stored in database 122a. Also, in other embodiments, only the device ID 504 and the dynamically assigned IP address 506 are stored in database 122a. In yet other embodiments, both device ID 504 and phone number 506 data exist in the database 122a, but one or the other may not be stored where the data has not been obtained. It is noted however, that at least one of the Device ID 504 or device phone number 506 is needed in addition to the dynamically assigned IP address 502 in order to perform one or more of the authentication processes described herein. It is further noted that in other embodiments additional information, such as location data may also be stored in either of the look-up tables 111a or 122a.

FIG. 6 is a flow-chart of a client authentication method 600 performed by a client device (114 or 124 of FIG. 1) in accordance with some embodiments. The client authentication method 600 may be governed by instructions that are stored in a computer readable storage medium and that are executed by one or more processors of one or more servers. Each of the operations shown in FIG. 6 may correspond to instructions stored in a computer memory or computer readable storage medium. The computer readable storage medium may include a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors. Specifically, many of the operations shown in FIG. 6 correspond to instructions in the authentication processing module 230 of the client device or system 114/124 shown in FIG. 2.

User input indicative of a payment processing request is received 601. For example, the user desires to purchase a good or service offered by a retailer or service provider server (140, FIG. 1), and thus provides input to pay for the good or service. In some embodiments, the input includes the selection of a payment or authentication button or request on a touch sensitive display screen. In other embodiments, the input is performed by activating a physical button on a client device such as a keyboard, mouse, or touchscreen. In yet other embodiments the user input is a voice command. Other similar mechanisms may also be used in order to receive input indicative of a payment processing request. The request may be initiated from a merchant's website that requires device authentication be performed prior to the purchase being made. For example, in some embodiments, the authentication option is a button stating “verify by phone number.” In other embodiments, the authentication is made via a dedicated application on the user device. For example, in some embodiments the user sets up a payment authentication requirement on his mobile device such that, in order to use the device to make a purchase, an operator must first type in the phone number associated with the device. In some embodiments the specific payment mechanism utilized at the end of the authentication is unrelated to the authentication itself. For example, after the authentication is complete, the user may choose to pay by credit card, debit card, Paypal account, secure online money transfer, phone number billing, or other means.

In some embodiments, an IP address, and/or a device ID, and/or a phone number of the client device is captured at 602. In some embodiments, the capture is machine implemented, and occurs without additional human intervention, while in other embodiments at least a portion of the capture is received from user input (e.g., the user enters the device's phone number). As explained in more detail with respect to FIG. 9, when the client device is a mobile telephone 124 it necessarily has a phone number. However, in the event that the client device does not have a telephone number, such as when the client device is, for example, a desktop computer, the device's ID (e.g., MAC address) is used for authentication instead of a phone number in accordance with some embodiments.

Therefore, in some embodiments, at least the IP address and the device ID is captured 602. In other embodiments, at least the IP address and either the device ID or the phone number is captured 602. In yet other embodiments the IP address, the device ID, and the client device phone number are captured.

A payment processing request is then generated 603. The payment processing request includes at least some of the captured client device data 603. In some embodiments, the payment processing request includes a subset of the captured client device data. For example, in some embodiments, the payment processing request includes only the device's phone number. Including only a subset of the device's data adds a layer of security to the payment authentication process by keeping the remaining information locally (on the client device).

The generated payment processing request, including at least some captured client device data, is then transmitted for authentication 604. In some embodiments, the payment processing request is transmitted to an authentication service provider server (160, FIG. 1). In other embodiments, the payment processing request is transmitted to a retailer/service provider server (140, FIG. 1). For example, in some embodiments, a trusted merchant performs the authentication method, as is described in FIG. 7 below. Similarly, in other embodiments, instead of a trusted merchant performing the authentication method, a separate authentication server performs the authentication method, as is described in both FIG. 8 and FIG. 9.

Once the authentication method has been performed, e.g., in accordance with one of the methods described in FIG. 7, 8, or 9, the client device 114/124 receives an authorization response 605. In some embodiments, the authorization response is received from the authentication service provider server (160, FIG. 1). In other embodiments, the authorization response is received from the retailer/service provider server (140, FIG. 1).

After the authorization response is received, the client determines whether the transaction is approved 606. In some embodiments, an approval determination includes reviewing an authentication status provided (by the authentication server or the merchant's server). For example, an “approved” or “not approved” message may appear in the received authorization response, and the client determines whether the transaction is approved by reading the received authorization response. In other embodiments, the authorization response includes data about the client device which was not provided in the client's payment processing request. In this embodiment, the client determines whether the transaction is approved by determining that the data in the authorization response matches the data that was not transmitted for authentication. For example, in some embodiments, the client captures an IP address, a device ID and/or a client phone number (at 602), the client transmits only the phone number in the payment processing request (at 604), and then receives a client IP address and/or device ID in the authorization response (at 605). In this example, the client determines if the transaction is approved 606 by determining if the IP address and/or device ID matches of the authorization response (at 605) matches the IP address and/or the device ID that it originally captured (at 602).

As such, the transaction approval 606 is performed by matching any un-transmitted client device data with client device data received in the authorization response. For example, in some embodiments, transaction approval 606 is performed by matching an un-transmitted client device phone number with a received client device phone number provided in the authorization response. In yet other embodiments, the transaction approval 606 is performed by matching an un-transmitted client device ID with a received client device ID provided in the authorization response. In still other embodiments, the transaction approval is performed by matching an un-transmitted client device IP address with a received client device IP address provided in the authorization response. In some embodiments, for increased security at least two pieces of un-transmitted client data are matched in order for the transaction to be approved. For example, in some embodiments, transaction approval is performed by matching an un-transmitted client device phone number and client device ID with a received client device phone number and client device ID provided in the authorization response. Similarly, in some embodiments, transaction approval is performed by matching an un-transmitted client device phone number and IP address with a received client device phone number and IP address provided in the authorization response. Likewise, in some embodiments, transaction approval is performed by matching an un-transmitted client device ID and IP address with a received client device ID and IP address and provided in the authorization response.

In the event that the transaction is approved (because, for example, one or more pieces of client device data does match), the transaction is completed 607. It is noted that once the transaction is approved the user is allowed to provide payment by any available mechanism allowed by the service provider such as by credit card, debit card, secure online money transfer, phone number billing (as discussed for example in U.S. Pat. No. 7,080,049), or the like. Once the transaction is completed (e.g., the user has successfully paid for the good or service desired) a purchase confirmation is provided 608.

In the event that the transaction is not approved (because for example one or more pieces of client device data did not match), the transaction ends 609. In some embodiments, when the transaction is not approved, a fraud report is also transmitted to the authentication service provider server 160. In some embodiments, the fraud report is additionally or alternatively transmitted to the retailer/service provider 140. In some embodiments, the fraud report includes GPS coordinates associated with the client device. In some embodiments, the GPS coordinates associated with the client device are obtained at the time of the fraud report creation. In other embodiments, the GPS coordinates are obtained along with obtaining the device data at 602.

In some embodiments, the GPS coordinates are sent to the carrier for authentication that they are close to the geographic location of the tower in communication with the device.

The mechanisms described herein add security to an online payment process by first verifying that a payment processing request from a client device is legitimately associated with the phone number or device ID of that client device. This additional level of security may be especially advantageous for a merchant. Furthermore, these methods allow the user to add a personal level of security to purchases made by a mobile phone device when the user requires explicit user input of data associated with the device, such as the device's phone number.

FIG. 7 is a flow-chart of a merchant authentication method 700 performed by a retailer/service provider server (140 of FIG. 1), sometimes referred to has a merchant server herein), in accordance with some embodiments. The merchant authentication method 700 may be governed by instructions that are stored in a computer readable storage medium and that are executed by one or more processors of one or more servers. Each of the operations shown in FIG. 7 may correspond to instructions stored in a computer memory or computer readable storage medium. The computer readable storage medium may include a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors. Specifically, many of the operations shown in FIG. 7 correspond to instructions in the authentication processing module 360 of the retailer/service provider 140 shown in FIG. 3.

In some embodiments, the merchant authentication method is performed in conjunction with the client authentication method 600 of FIG. 6. In some embodiments, a merchant authentication method 700 is performed by a trusted merchant. In some embodiments, a merchant is trusted when it is large and/or well known. For example, in some embodiments, a well known online sales website is a trusted merchant. In some embodiments, a website associated with a well known brick and mortar store is also a trusted merchant. In yet other embodiments, a trusted merchant is a merchant with a high level of security. For example, a trusted merchant may have additional password, biometrics, or confirmations required in order to perform a transaction. One exemplary trusted merchant is a banking website.

The merchant server (e.g. 140, FIG. 1) receives user input indicative of a payment processing request 701. In some embodiments, the input is received from a client device (114/124, FIG. 1). The merchant server then transmits a request for device data 702. A response with the client device data is received at 703. In some embodiments, the response is provided from the client. In other embodiments, the response comes from an authentication service provider server 160.

The merchant server 140 then determines if valid device data has been received at 704. In some embodiments, the merchant server determines that the device data is valid if at least a minimum amount of client device data has been received. For example, in some embodiments, it determines that valid device data has been received if at least one of the client's IP address, the client device's ID, a SIM card associated with a home country, a SIM card associated with a country or location in which the user is travelling, a dedicated number (e.g., a Google Voice number), or the client device's phone number has been received. In other embodiments, the merchant server requires at least two of the above mentioned device data components to determine that the client device data is valid. Furthermore, in some embodiments, in addition to meeting a minimum threshold of received client device data, the merchant server also determines that the received data is proper. In some embodiments, device data is determined to be proper and thus valid, when the data meets a standard format (e.g., a US phone number is considered standard if it has 10 digits, e.g., 202-555-7519). In other embodiments the information determined to be proper when it matches generally applicable information. For example, a phone number may be proper when the first three digits match a known area code for the region (e.g., 202 for Washington D.C.). In yet other embodiments, the information is checked against previously provided information to determine that the device data is valid. For example, if a phone number was provided in a previous transaction with the same client device, the data is considered valid if currently provided number is identical to the previously provided number. It should be noted that failure to pass one or more validation tests does not necessarily mean the data is deemed invalid. However, passing a stricter validation test provides a higher level of confidence that the data is indeed valid and is thus is preferred in some embodiments.

When the merchant server determines that valid device data has not been received because it does not meet a minimum validation test (the threshold of which varies depending on the embodiment) then the transaction ends at 710.

When the merchant server determines that valid device data has been received, at least a portion of the device data is transmitted to be verified at 705. In some embodiments, some or all of the device data is transmitted to an authentication server (160, FIG. 1). In other embodiments, a portion of the device data is transmitted to an authorization system such as phone carrier (120, FIG. 1) or internet service provider (111, FIG. 1). In some embodiments, the IP address of the client device, the client device ID, and the client device phone number are all transmitted. In other embodiments only one of these pieces of data is transmitted. In other embodiments two pieces of data are transmitted. For example, the IP address and the device ID are transmitted. In other embodiments, at least the IP address and either the device ID or the phone number is transmitted. In some embodiments, any client device data received is transmitted. In other embodiments, less than all of the data received is transmitted. Providing less-than-all of the client data received adds an additional level of security by keeping some of the client's data at the merchant server and increases the ability to independently perform a match confirmation as explained below. As such, in some embodiments, this is the preferred this technique.

In some embodiments, the authentication server performs an analysis as illustrated in FIG. 8 or FIG. 9 below. Then an authentication server response is received 706 from the authentication server. In some embodiments the response is an indication of whether the transaction is “approved” or “not approved.” In other embodiments, the response provides a piece of information about the client device which was not transmitted by the merchant server to the authentication server (or other authorization system) at 705. In embodiments where the information is sent directly to the phone carrier or internet service provider, the response 706 is received directly from the queried system.

Once the response is received, the merchant server determines whether a valid match is confirmed at 707. In some embodiments, a valid match determination includes reviewing response provided to see if an “approved” or “not approved” message was received. In other embodiments, the merchant server determines whether the transaction is approved by determining that the data in the authentication response matches un-provided data that the merchant has about the client device. For example, in some embodiments, the merchant server received the client's IP address and device ID, transmitted only the device ID to the authentication server (at 705), and then received a client's IP address from the authentication server (at 706). In this example, then the merchant server determines if there is a valid match by determining if the IP address received from the authentication server matches IP address received from the client device.

Similarly, in another example, the merchant server may have received the client's IP address, device ID, and phone number; transmitted only the device ID and phone number to the authentication server (at 705), and then received a client's IP address from the authentication server (at 706). In this example, then the merchant server determines if there is a valid match by determining if the IP address received from the authentication server matches IP address received from the client device.

In some embodiments, to confirm a valid match 707 the merchant server may compare two pieces of un-transmitted data. For example, the merchant server may have received the client's IP address, device ID, and phone number; transmitted only the device ID to the authentication server (at 705), and then received a client's IP address and phone number from the authentication server (at 706). In this example, then the merchant server determines if there is a valid match by determining if both the IP address and the phone number received from the authentication server matches IP address and phone number received from the client device.

When the merchant server determines that there is not a valid match at 707 received (because for example one or more of the pieces of data received from the authentication server do not match those received from the client) then the transaction ends at 710. In some embodiments, a fraud report, as described with reference to FIG. 6, is also generated by the merchant server or the client.

In the event that the merchant server determines that there is a valid match at 707 (because for example one or more pieces of date received from the authentication server do match the data received from the client device), the authentication transaction is completed 708. The merchant then completes the purchase (by any mechanism allowed by the merchant) and once the transaction is completed (e.g., the user has successfully paid for the good or service desired) a purchase confirmation is provided 709.

FIG. 8 is a flow-chart of an authentication method 800 performed by an authentication service provider server (160 of FIG. 1) in accordance with some embodiments. The authentication method 800 may be governed by instructions that are stored in a computer readable storage medium and that are executed by one or more processors of one or more servers. Each of the operations shown in FIG. 8 may correspond to instructions stored in a computer memory or computer readable storage medium. The computer readable storage medium may include a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors. Specifically, many of the operations shown in FIG. 8 correspond to instructions in the transactions processing module 440 of the authentication service provider 160 shown in FIG. 4.

In some embodiments, the authentication method 800 is performed in conjunction with the client authentication method 600 and/or the merchant authentication method 700.

In some embodiments, the authentication server (e.g. 161, FIG. 1) receives a payment processing request 801. In some embodiments, the processing request is received from a client device (114/124, FIG. 1) while in other embodiments it is received from a merchant server. In most embodiments where the request is received from the merchant server, the request includes at least some client device data (as described in 705, FIG. 7) and thus the process continues at step 804.

In other embodiments, such as in some embodiments where the client interacts directly with the authentication server, the process continues at step 802. In some embodiments, the authentication server then transmits a request for device data 802 to the client device. A response with the client device data is received 803. In some embodiments, the response is provided from the client 114/124. In other embodiments, the response is provided from the retailer/service provider 140.

The authentication service provider 160 determines if valid device data has been received at 804. In some embodiments, similar to the merchant server determination described with respect to FIG. 7, the authentication server determines that the device data is valid if at least a minimum amount of client device data has been received. For example, in some embodiments, it determines that valid device data has been received if at least one of the client's IP address, the client device's ID, or the client device's phone number has been received. In other embodiments, the authentication server requires at least two of the above mentioned device data components to determine that the data is valid. Furthermore, in some embodiments, in addition to meeting a minimum threshold of received client device data, the authentication server also determines that the received data is proper, as described above with respect to FIG. 7.

When the authentication determines that valid device data has not been received because it does not meet a minimum validation test (the threshold of which varies depending on the embodiment) then the transaction ends at 810.

When the authentication server determines that valid device data has been received, the process continues. In some embodiments, a phone number and an IP address are extracted from the received client device data at 805. A phone carrier is then queried with either the phone number or the IP address 806. In some embodiments, the phone number is preferably used for transmission. A phone carrier response is received at 807. Depending on the carrier the data in the response may vary. In some embodiments, the phone carrier response includes an IP address. In other embodiments the carrier response includes the client device ID. The carrier response includes at least one a piece of information about the client device which was not transmitted by the authentication server to the carrier.

In other embodiments, two distinct identifiers (e.g., telephone number and IP address) are sent to the carrier, and the carrier itself performs the comparison.

Once the carrier response is received, the authentication server determines whether there is a device data match at 808. In some embodiments, the authentication server determines that the data in the carrier response matches data not provided to the carrier but that the authentication server has obtained the client device similar to the matching described with respect to FIGS. 6 and 7. For example, in some embodiments, the authentication server extracts the client's phone number and IP address, transmits only the phone number to the carrier (at 806), and then receives the client's IP address from the carrier (at 807). In this example, the authentication server determines if there is a device match (at 808) by determining if the IP address received from the carrier matches extracted client device IP address.

In some embodiments, when the authentication server determines that there is not a client device match at 808 then the transaction ends and/or a fraud report is created at 810. Details regarding the creation of a fraud report, are described with reference to FIG. 6. Furthermore, in some embodiments the authentication server sends a response to the client or the merchant server (depending on the embodiment), wherein the response indicates that the transaction was “not approved.”

When the authentication server determines that there is a client device match at 808, then the authentication server provides authorization to complete the transaction at 809. In some embodiments, the authorization includes a message that the transaction “is approved.” In other embodiments the authentication server also provides the information received from the carrier back to the merchant or the client for further processing and approval as described with respect to FIGS. 6 and 7. The merchant and client then complete the purchase as described with respect to FIGS. 6 and 7.

FIG. 9 is a flow-chart of another authentication method 900 performed by an authentication service provider server (160 of FIG. 1) in accordance with some embodiments. The authentication method 900 may be governed by instructions that are stored in a computer readable storage medium and that are executed by one or more processors of one or more servers. Each of the operations shown in FIG. 9 may correspond to instructions stored in a computer memory or computer readable storage medium. The computer readable storage medium may include a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors. Specifically, many of the operations shown in FIG. 9 correspond to instructions in the transactions processing module 440 of the authentication service provider 160 shown in FIG. 4.

In some embodiments, the authentication method 900 is performed in conjunction with the client authentication method 600 and/or the merchant authentication method 700.

In some embodiments, the authentication server (e.g. 160, FIG. 1) receives a payment processing request including device data 901 (as described in more detail with respect to 801-803 in FIG. 8). In some embodiments, the processing request is received from a client device (114/124, FIG. 1) while in other embodiments it is received from a merchant server (140, FIG. 1).

The authentication service provider 160 determines if valid device data has been received at 902. In some embodiments, similar to the merchant server determination described with respect to FIG. 7, the authentication server determines that the device data is valid if at least a minimum amount of client device data has been received. Furthermore, in some embodiments, in addition to meeting a minimum threshold of received client device data, the authentication server also determines that the received data is proper as described above with respect to FIG. 7.

When the authentication service provider 160 determines that valid device data has not been received, the authentication server transmits a message indicating reception of invalid data at 903. In some embodiments, the message is transmitted to the merchant server. In other embodiments the message is transmitted to the client device.

When the authentication service provider 160 determines that valid device data has been received, the process continues. The authentication sever then determines if a phone number has been included at 904. If a phone number was not included, then the authentication server determines if a device ID is included at 909. If neither a phone number nor a device ID is included than the authentication server transmits a message indicating reception of invalid data at 903 as described above.

When a phone number is determined to be included at 904, then the process continues as described with respect to FIG. 8. Specifically, the process is outlined here for the sake of completeness. A phone carrier is queried with at least one of the phone number or the IP address at 905. A phone carrier response is received at 906. Depending on the carrier the data in the response may vary. In some embodiments, the carrier response includes an IP address. In other embodiments the carrier response includes the client device ID. The carrier response includes at least one a piece of information about the client device which was not transmitted by the authentication server to the carrier. Once the carrier response is received, the authentication server determines whether there is a device data match at 907. In some embodiments, the authentication server determines that the data in the carrier response matches un-provided data that the authentication server has about the client device as described above. When the authentication server determines that there is a client device match at 907 then the authentication server provides authorization to complete the transaction at 908 as described above.

However, unlike the process shown in FIG. 8, when the authentication server determines that there is not a client device match at 907 then the authentication process continues as follows. The authentication server determines if a device ID was included in the carrier response at 915.

If the authentication server determines that a device ID was included in either the carrier response (at 915) or in the originally received device data that did not include a phone number (at 909) then authentication is attempted using the device ID.

The processing request is parsed for the Internet Service Provider (ISP) 910. Then a determination is performed to assess if the ISP is known at 911. If the ISP is not known then the transaction ends and a message indicating authorization failure is provided at 914. If the ISP is known, then the ISP is queried with at least one of the device ID or device IP address at 912. In some embodiments, the ISP is preferably queried with the device ID.

Then once a response is received from the ISP and a device match is performed 913. The authentication server determines whether there is a device data match. In some embodiments, the authentication server determines that the data in the ISP response matches un-provided data that the authentication server has about the client device similar to the matching described with respect to FIGS. 6 and 7. For example, when the authentication server, transmitted only the device ID to the ISP and then received a client's IP address from the ISP, then the authentication server determines if there is a device match (at 913) by determining if the IP address received from the ISP matches client device IP address it has.

When the authentication server determines that there is not a client device match at 913 then the transaction ends and a message indicating authorization failure is transmitted to the client 114/124 and/or the merchant server 140. In some embodiments, the authentication server sends the authorization failure response to the client or the merchant server (depending on the embodiment), wherein the response indicates that the transaction was “not approved.” In some embodiments, a fraud report is created as well. Details regarding the creation of a fraud report are described with reference to FIG. 6.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. For example, other identifiers may be used to authenticate a user travelling in a foreign country. These identifies may include a SIM card associated with a home country, a SIM card associated with a country or location in which the user is travelling, a dedicated number (e.g., a Google Voice number), or any other suitable identifier.

What is claimed is:

1. A method for authorizing a payment transaction initiated on a mobile client device connected to a cellular communication network, the method comprising:
at a system having one or more processors and memory storing one or more programs for execution by the one or more processors to perform the method:
receiving from a mobile client device connected to a cellular communications network a request to authorize a payment transaction initiated on the client device, where the request comprises an IP address associated with a client device and a cellular phone number associated with the client device;
querying a carrier system associated with the cellular communications network using the cellular phone number associated with the client device;
receiving a response from the carrier system, wherein the response includes an IP address associated with the client device; and
at least partially authorizing the payment transaction when the IP address received from the carrier system matches the IP address received from the client device.

2. The method of claim 1, further comprising, before the receiving:
receiving a payment processing transaction request from the mobile client device; and
transmitting a request for client device data to the mobile client device.

3. The method of claim 1, further comprising, before the receiving:
receiving a payment processing transaction request from a merchant; and
transmitting a request for client device data to the merchant.

4. The method of claim 1, wherein the IP address is determined automatically without human intervention from the request.

5. The method of claim 1, wherein the cellular phone number is determined automatically without human intervention.

6. The method of claim 1, wherein the cellular phone number is obtained from direct user input into the mobile client device.

7. The method of claim 1, wherein the authentication system is operated by an internet service provider.

8. The method of claim 1, further comprising providing a failure message when the IP address received from the carrier system does not match the IP address received from the client device.

9. The method of claim 1, further comprising notifying a user associated with the client device that illicit activity may be occurring with the mobile client device when the IP address received from the carrier system does not match the IP address received from the client device.

10. A method for authorizing a payment transaction initiated on a mobile client device connected to a cellular communication network, the method comprising:
at a system having one or more processors and memory storing one or more programs for execution by the one or more processors to perform the method:
receiving a request to authorize a payment transaction initiated on a portable client device connected to a cellular communications network, the request comprising first client device data including an IP address and a unique identifier both associated with the client device;
querying an authentication system using a subset of the first client device data;
receiving a response from the authentication system, wherein the response includes second client device data distinct from the subset of the first client device data; and
at least partially authorizing the payment transaction when at least some of the second client device data received from the authentication system matches at least some of the second client device data received from the client device.

11. The method of claim 10, wherein the IP address is determined automatically without human intervention from the request.

12. The method of claim 10, wherein the cellular phone number is determined automatically without human intervention.

13. The method of claim 10, wherein the cellular phone number is obtained from direct user input into the mobile client device.

14. The method of claim 10, further comprising providing a failure message when the IP address received from the carrier system does not match the IP address received from the client device.

15. The method of claim 10, further comprising notifying a user associated with the client device that illicit activity may be occurring with the mobile client device when the IP address received from the carrier system does not match the IP address received from the client device.

16. The method of claim 10, wherein the unique identifier includes a cellular phone number, a client device ID, a SIM card number, or an IMEI number.

17. The method of claim 10, wherein the subset of first client device data includes at least one of: the IP address associated with a client device, the cellular phone number associated with a client device, a client device ID, a SIM card number associated with a client device, or an IMEI number associated with a client device.

18. The method of claim 10, wherein the subset of the first client device data includes at least one of: the IP address associated with a client device, the cellular phone number associated with a client device, a client device ID, a SIM card number associated with a client device, or an IMEI number associated with a client device.

19. An authentication system, comprising:
one or more processors;
memory; and
one or more programs stored in the memory, the one or more programs comprising instructions for:
receiving from a mobile client device connected to a cellular communications network a request to authorize a payment transaction initiated on the client device, where the request comprises an IP address associated with a client device and a cellular phone number associated with the client device;
querying a carrier system associated with the cellular communications network using the cellular phone number associated with the client device;
receiving a response from the carrier system, wherein the response includes an IP address associated with the client device; and
at least partially authorizing the payment transaction when the IP address received from the carrier system matches the IP address received from the client device.

20. A non-transitory computer readable storage medium storing one or more programs configured for execution by one or more processors of an authentication system, the one or more programs comprising instructions for:
receiving from a mobile client device connected to a cellular communications network a request to authorize a payment transaction initiated on the client device, where the request comprises an IP address associated with a client device and a cellular phone number associated with the client device;
querying a carrier system associated with the cellular communications network using the cellular phone number associated with the client device;
receiving a response from the carrier system, wherein the response includes an IP address associated with the client device; and
at least partially authorizing the payment transaction when the IP address received from the carrier system matches the IP address received from the client device.
